(19) United States
(12) Patent Application Publication
(10) Pub. No.: US 2003/0156501 A1
(43) Pub. Date: Aug. 21, 2003

(54) Trackable storage unit system and method

(76) Inventors: Martin Spindel, New York, NY (US); Nadine Cino, New York, NY (US)

Correspondence Address: PENNIE AND EDMONDS, 1155 AVENUE OF THE AMERICAS, NEW YORK, NY, 100362711

(21) Appl. No.: 10/341,448

(22) Filed: Jan. 13, 2003

Related U.S. Application Data
(60) Provisional application No. 60/348,120, filed on Jan. 14, 2002.

(51) Int. Cl. H04B 1/20

(52) U.S. Cl. 369/1

(57) ABSTRACT

A trackable storage unit system comprising a plurality of stackable storage units, each storage unit having a computer chip containing data concerning the storage unit, a carrier for carrying a plurality of stacked storage units, the carrier having a first transceiver, electrical connections between the carrier and at least a first storage unit in the stack of storage units carried by the carrier and between adjacent storage units in the stack of storage units carried by the carrier, the electrical connections enabling the first transceiver on the carrier to transmit and receive data to and from the computer chips of the storage units in the stack of storage units; and a second remote transceiver for receiving and transmitting data to and from the first transceiver. The second remote transceiver transmits and receives data to and from the computer chips of the plurality of storage units via the first transceiver and the electrical connections to track the plurality of storage units. A central power source on the carrier may supply power to the computer chips in the stack of storage units via the electrical connections between the storage units. The storage units may be boxes, file folders or any other type of container.

### RELATED APPLICATIONS

This application claims priority to U.S. Provisional Patent Application Serial No. 60/348,120, filed Jan. 14, 2002.

### FIELD OF THE INVENTION

The present invention relates to the tracking of storage units, i.e., storage boxes, file folders, etc. More particularly, the present invention relates to a system and method for tracking and controlling the movement of storage units during home or office relocations.

### BACKGROUND OF THE INVENTION

Hundreds of boxes are often required to move a business from one office space to another. As one might imagine, boxes are sometimes misplaced, or even lost, during such moves. Systems involving bar coding and/or Radio Frequency Identification (RFID) tags have been employed to track boxes during the moving process, but these solutions have several drawbacks. For example, a bar code reader can only communicate with one bar code label at a time, and RFID tags, which may each have their own separate power supply, are both expensive and have limited range.

The present invention allows an electrical current to be supplied from a central power source to any or all storage units, e.g., boxes, file folders, etc., within a stack. Such current can be used to effectively drive a large variety of devices that could be attached to the boxes. As examples, such devices might include computer chips, Radio Frequency Identification (RFID) tags, Light Emitting Diode (LED) displays, digital clocks, light bulbs or sound speakers. Thus, a single battery located on a cart, pallet or shelf could supply power to any or all boxes loaded on it. This would result in a significant savings of cost, weight and space as compared to placing a separate battery on each box. Similarly, other components of attached devices (e.g., keypads) could be located on a central cart rather than on each box.

In the case of attaching computer chips to the boxes, the data on such chips could be used to wirelessly track and control the boxes as they pass through the various channels during a move. Since the required chips would be relatively inexpensive, the present invention may effectively provide the speed and power of RFID at about the cost of bar coding. Additionally, by supplying power from a central battery, the invention may be able to substantially increase the range of RFID tags at little or no cost.

While bar code reading devices can only communicate with one label at a time, and an RFID antenna can only communicate with all tags within a range (i.e., in general, the antenna cannot communicate with only one tag located within a range that includes multiple tags), the present invention would allow communication with one, all or any combination of computer chips within a group. As an example, a different customer name could be written at a relatively high speed to each of a large number of chips within a group of chips. Accordingly, the present invention combines the specificity of bar coding with the speed of RFID.

### SUMMARY OF THE INVENTION

In a preferred embodiment, the present invention relates to a storage unit system comprising a plurality of stackable storage units each storage unit having electrical connections between itself and adjacent storage units in a stack of storage units. The electrical connections enable an electrical current to flow from storage unit to storage unit, and to any of a variety of electrically powered devices that may be attached to such storage units. Since the electrical connectors are modular, additional storage units may be added to a stack and electronically connected to adjacent units.

The system may further comprise a carrier for carrying a plurality of stacked storage units, a central power source on the carrier that is removably attached to, and supplies electrical power to, a first storage unit, such electrical power flowing to adjacent storage units through the electrical connections. The plurality of storage units may be stacked vertically or horizontally. The storage units may be boxes, file folders, or any other type of container.

In another preferred embodiment, the present invention is a method for passing an electrical current through a plurality of storage units in a storage unit system having a plurality of stackable storage units, with each storage unit having an electrical connection between itself and adjacent storage units in the stack of storage units. The method comprises the flow of an electrical current from storage unit to storage unit via the electrical connections, and to any of a variety of electrically powered devices that may be attached to such storage units. Since the electrical connectors are modular, additional storage units may be added to a stack and electronically connected to adjacent storage units.

In still another preferred embodiment, the present invention relates to a trackable storage unit system comprising a plurality of stackable storage units, each storage unit having a computer chip containing data concerning the storage unit, a carrier for carrying a plurality of stacked storage units, the carrier having a first transceiver, electrical connections between the carrier and at least a first storage unit in the stack of storage units carried by the carrier and between adjacent storage units in the stack of storage units carried by the carrier, the electrical connections enabling the first transceiver on the carrier to transmit and receive data to and from the computer chips of the storage units in the stack of storage units, and a second remote transceiver for receiving and transmitting data to and from the first transceiver. The second remote transceiver transmits and receives data to and from the computer chips of the plurality of storage units via the first transceiver and the electrical connections to track the plurality of storage units.

The system may further comprise a central power source on the carrier for supplying power to the computer chips in the stack of storage units via the electrical connections between the storage units. The plurality of storage units may be stacked vertically or horizontally. The storage units may be boxes, file folders, or any other type of container. The carrier may be a cart for moving storage units, a shelving unit, a cargo pallet or similar item. The data contained on each computer chip may include identification data for each storage unit.

In another preferred embodiment, the present invention is a method for tracking a plurality of storage units in a storage unit system having a plurality of stackable storage units, with each storage unit having a computer chip containing data concerning the storage unit, a storage unit carrier having a first transceiver with electrical connections between the carrier and at least a first storage unit in the stack of storage units carried by the carrier and between adjacent storage units in the stack of storage units carried by the carrier, and a second remote transceiver for receiving and transmitting data to and from the first transceiver. The method comprises transmitting data between the computer chips in the stack of storage units and the first transceiver on the carrier via the electrical connections between adjacent storage units in the stack of storage units, transmitting the data between the first transceiver and the second transceiver, and monitoring the data received by the second transceiver.

In still another preferred embodiment, the present invention relates to a trackable storage unit system comprising a plurality of storage units, each storage unit having a computer chip containing data concerning the storage unit, a carrier for carrying a plurality of storage units, the carrier having a first transceiver, a central power source connected to the carrier for supplying power to the computer chips of the plurality of storage units, electrical connections between the carrier and each of the plurality of storage units carried on the carrier, the electrical connections enabling the central power source to supply power to the computer chips of the storage units in contact with the carrier and enabling the first transceiver on the carrier to transmit and receive data to and from the computer chips of the plurality of storage units in contact with the carrier, and a second remote transceiver for receiving and transmitting data to and from the first transceiver. The second remote transceiver transmits and receives data to and from the computer chips of the plurality of storage units via the first transceiver and the electrical connections to track the plurality of storage units. The plurality of storage units may be boxes, file folders, or any other similar item. The carrier may be a shelving unit, wheeled cart, or any similar item. The data contained on each computer chip includes identification data for each storage unit.

In yet another preferred embodiment, the present invention relates to a method for tracking a plurality of storage units in a storage unit system having a plurality of storage units, with each storage unit having a computer chip containing data concerning the storage unit, a storage unit carrier having a first transceiver with electrical connections between the carrier and each of the plurality of storage units carried on the carrier, a central power source connected to the carrier for supplying power to the computer chips of the plurality of storage units via the electrical connections, and a second remote transceiver for receiving and transmitting data to and from the first transceiver. The method comprises supplying power to the computer chips of the plurality of storage units in contact with the carrier via the electrical connections; transmitting data between the computer chips of the plurality of storage units in contact with the carrier and the first transceiver on the carrier via the electrical connections; transmitting the data between the first transceiver and the second transceiver; and monitoring the data received by the second transceiver.

Where a “transceiver” is used to communicate with computer chips in the preceding embodiments, other communications devices could be used in lieu of a transceiver. Such devices include, but are not limited to, handheld computers.

### BRIEF DESCRIPTION OF THE DRAWINGS

The present invention will be understood and appreciated more fully from the following detailed description, taken in conjunction with the drawings in which:

FIG. 1 shows a box outfitted with a Modular Electronic Connector (“MEC”) in accordance with one preferred embodiment of the present invention;

FIG. 2 is a front view of the box of FIG. 1;

FIG. 3 shows two vertically stacked boxes, each of which is outfitted with a Modular Electronic Connector (hereinafter referred to as a “MEC Box”);

FIG. 4 shows four stacked MEC Boxes, which are electronically connected to each other;

FIG. 5 shows four MEC Boxes stacked on top of a cart;

FIG. 6 shows the MEC Boxes and cart of FIG. 5 with a battery added to the cart (hereinafter referred to as a “MEC Cart”);

FIG. 7 shows the MEC Boxes and cart of FIG. 6 with a computer chip added to each MEC Box;

FIG. 8 shows the MEC Boxes and cart of FIG. 7 with a Radio Frequency Data Communication (RFDC) Transmitter/Receiver (hereinafter referred to as an “RFDC Unit”) added to the MEC Cart;

FIG. 9A is the same as FIG. 8 except that the computer chips have been replaced with RFID Tags;

FIG. 9B shows an RFID antenna;

FIG. 10A shows a MEC Box outfitted with an LED display;

FIG. 10B shows a MEC Box outfitted with colored lights;

FIG. 11 shows a MEC outfitted shelving unit (hereinafter referred to as a “MEC Shelf”);

FIG. 12 shows some of the devices that could be attached to a MEC Box;

FIG. 13 shows the difference in range between Active and Passive RFID tags;

FIG. 14A shows a MEC outfitted pallet (hereinafter referred to as a “MEC Pallet”);

FIG. 14B shows a forklift truck used to lift a MEC Pallet;

FIG. 14C shows a detailed view of a blade of the forklift truck of FIG. 14B;

FIG. 15 is an aerial view of the circuitry located on the underside of a MEC Cart, MEC Shelf, MEC Pallet or other MEC carrier;

FIG. 16A shows a large MEC Box containing other smaller MEC Boxes;

FIG. 16B shows a top view of the floor of the large MEC Box of FIG. 16A;

FIGS. 17A-17E show file folders outfitted with Modular Electronic Connectors in accordance with another embodiment of the present invention (hereinafter referred to as “MEC File Folders”);

FIGS. 18A-18D show MEC File Folders having a metallic coating in the form of a diagonal line across each of the front and back of the folders;

FIGS. 19A-19B show MEC File Folders on a shelving unit outfitted with rigid dividers (hereinafter “MEC Dividers”);

FIG. 20A shows a pair of MEC Carts;

FIG. 20B shows a network of connected MEC Carts;

FIGS. 21A-21C show how a Modular Electronic Connector is configured on a plastic box with a hinged lid;

FIGS. 22A-22D show how a Modular Electronic Connector is configured on a corrugated box; and

FIGS. 23A-23D show Modular Electronic Connectivity used on RFID tags, rather than on boxes.

### DETAILED DESCRIPTION OF THE PREFERRED EMBODIMENTS

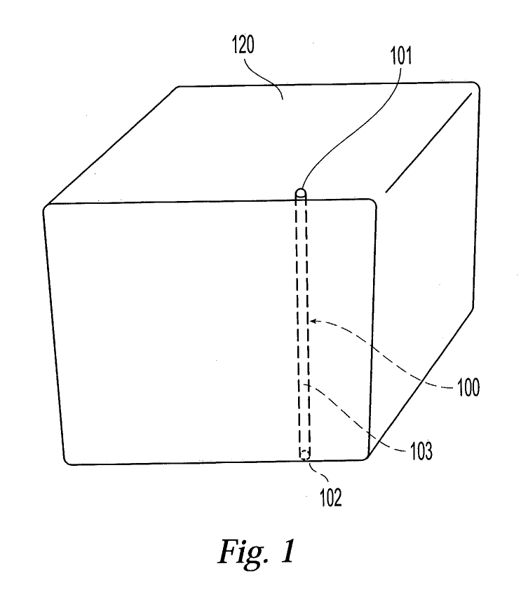

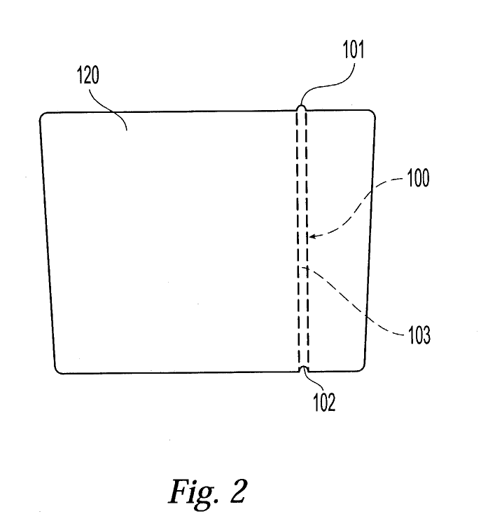

FIGS. 1 and 2 show a box 120 outfitted with a Modular Electronic Connector 100 on its front wall in accordance with a first preferred embodiment of the present invention. Modular Electronic Connector (“MEC”) 100 includes a Metal Male Nodule 101 at its top and a Metal Female Nodule 102 at its bottom. Metal Male Nodule 101 is essentially a convex shape that slightly protrudes from the top of MEC Box 120. Metal Female Nodule 102 is essentially a concave shape that forms a slight indentation into the bottom of the MEC Box. The two nodules are connected by metal filament 103 (illustrated by dotted lines to indicate that the viewer is effectively looking through the wall of the box), thereby allowing an electrical current to run between the top and bottom of box 120.

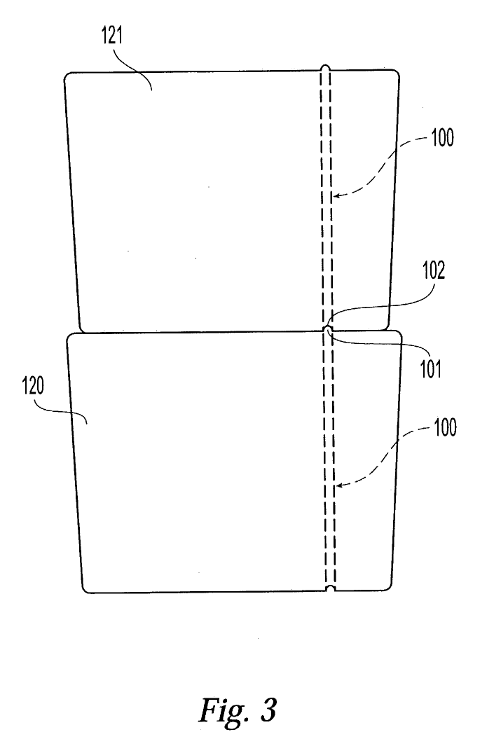

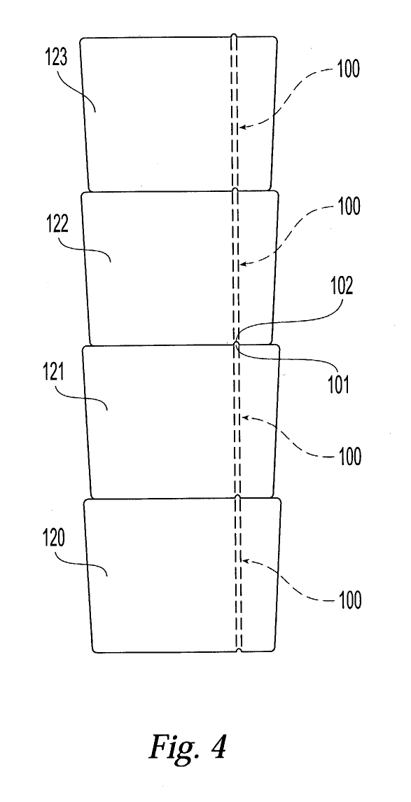

FIG. 3 shows two vertically stacked boxes 120, 121 each of which is outfitted with a Modular Electronic Connector 100 (hereinafter referred to as a “MEC Box”). By virtue of such invention, MEC Boxes 120, 121 are effectively connected to each other and an electrical current can run between them. The connection is modular so that additional MEC Boxes could be added to the stack and electronically connected to each other. FIG. 4 shows four MEC Boxes 120, 121, 122, 123 which are electronically connected to each other. In both FIGS. 3 and 4, Metal Male Nodule 101 on the top of the bottom MEC Box 120 fits into and mates with the Metal Female Nodule 102 on the bottom of the MEC Box 121 immediately above it. In that manner, bottom MEC Box 120 makes electronic contact with MEC Box 121 immediately above it, so that an electrical current can flow between the two MEC Boxes 120, 121. Similarly, an electrical current can flow from the second MEC Box 121 to the third and fourth MEC Boxes 122, 123.

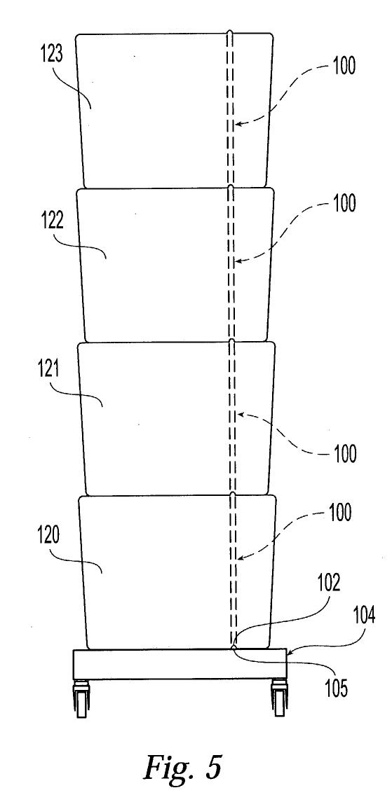

FIG. 5 shows four MEC Boxes 120, 121, 122, 123 with cart 104 beneath them. The top of the cart is outfitted with Metal Male Nodule105. Male Nodule 105 mates with Female Nodule 102 on the floor of bottom MEC Box 120, so that Metal Male Nodule. Cart 104, outfitted with one or more Metal Male Nodules 105, is hereinafter referred to as a “MEC Cart.” MEC Boxes 120, 121, 122, 123 are electronically connected to MEC Cart 104.

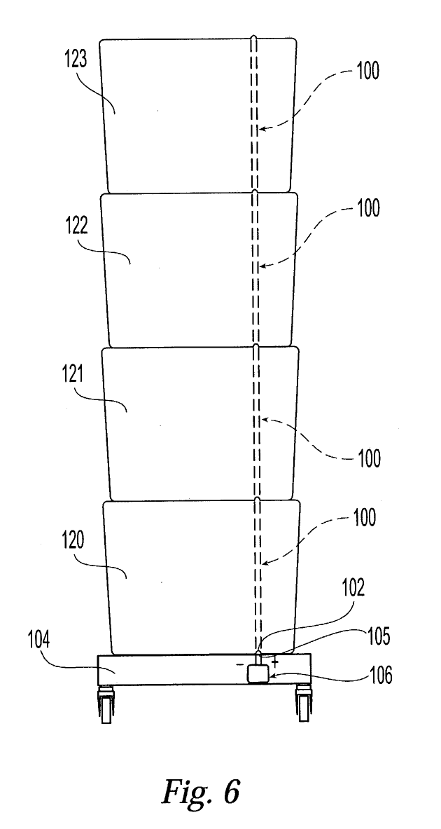

FIG. 6 is the same as FIG. 5 except that battery 106 has been added to MEC Cart 104. Battery 106 is connected to Male Nodule 105 on MEC cart 104 so that an electrical current can be run from cart 104 to each of the boxes 120, 121, 122, 123 stacked above it.

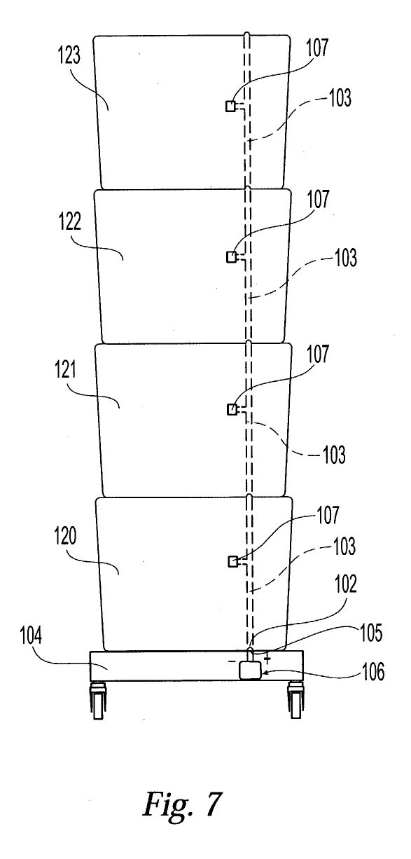

FIG. 7 is the same as FIG. 6 except that a computer chip 107 has been added to each MEC Box 120, 121, 122, 123. Computer chip 107 is connected to metal filament 103 on each MEC Box. Data on computer chip 107 can now flow along metal filament 103. Any type of media could be used as a chip (including but not limited to silicon), as long as it can store and communicate data in accordance with the requirements of the present invention.

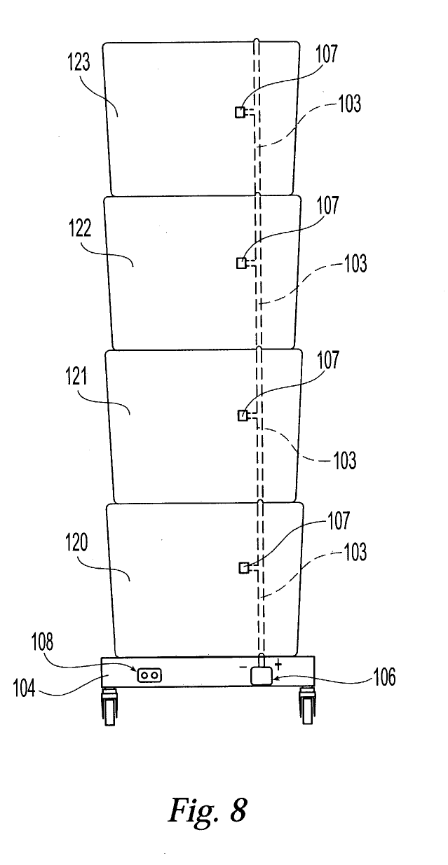

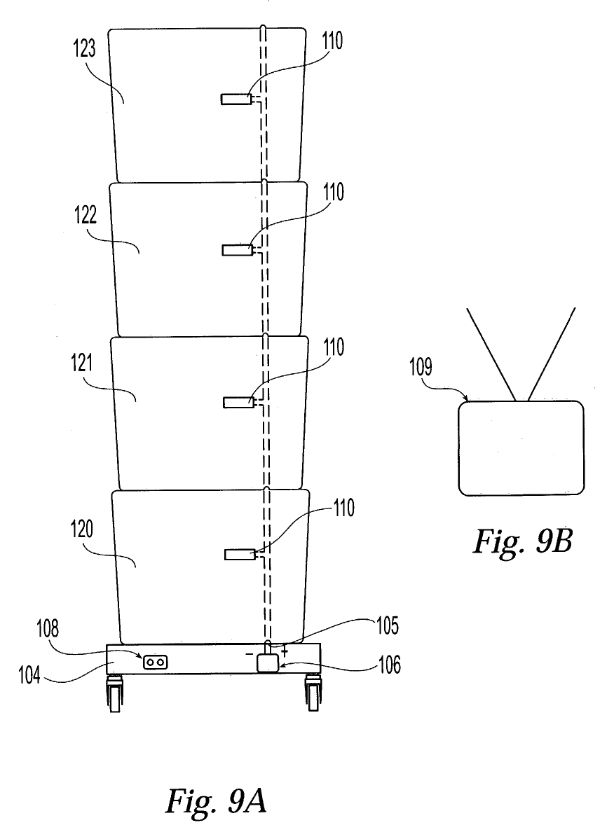

“RFDC” is an abbreviation for “Radio Frequency Data Communication.” FIG. 8 is the same as FIG. 7 except that an RFDC Transmitter/Receiver 108 (hereinafter referred to as an “RFDC Unit”) has been added to MEC Cart 104. The RFDC unit can communicate with a remote antenna (shown as 109 in FIG. 9B) which, for example, could be connected to a computer or other communications device. Accordingly, data on computer chips 107 can now be communicated to a computer (or other device) and visa versa. Each MEC Box 120, 121, 122, 123 is thereby effectively in communication with a remote computer (or other device). Communication can be with (i) one (ii) all or (iii) any combination of MEC Boxes on MEC Cart 104. As an alternative, a computer (or other device) could be connected directly to MEC Cart 104 without using an RFDC unit 108.

As discussed above, “RFID” is an abbreviation for “Radio Frequency Identification.” FIG. 9A is similar to FIG. 8 except that the computer chips on each MEC Box have been replaced with RFID tags 110. RFID tags communicate with a remote antenna, such as RFID antenna 109 shown in FIG. 9B. RFID antenna 109 can, in turn, communicate with a computer or other device. The computer chips inside RFID tags 110 may also be in communication with RFDC Unit 108 on MEC Cart 104. Accordingly, data on the computer chips can now be communicated to a computer (or other device) via either RFID or RFDC. Communications via RFDC can be used to activate or de-activate the RFID Tag on any MEC Box in the stack shown. For example, the tags on the top MEC Box could be activated while the three lower boxes are de-activated. This would allow the RFID Antenna to read only the tag on the top box, thereby distinguishing it from the other boxes. Similarly, communication via RFDC could be used to cause the RFID tags to flash on and off at differential rates. This could be used to send coded messages to the RFID Antenna.

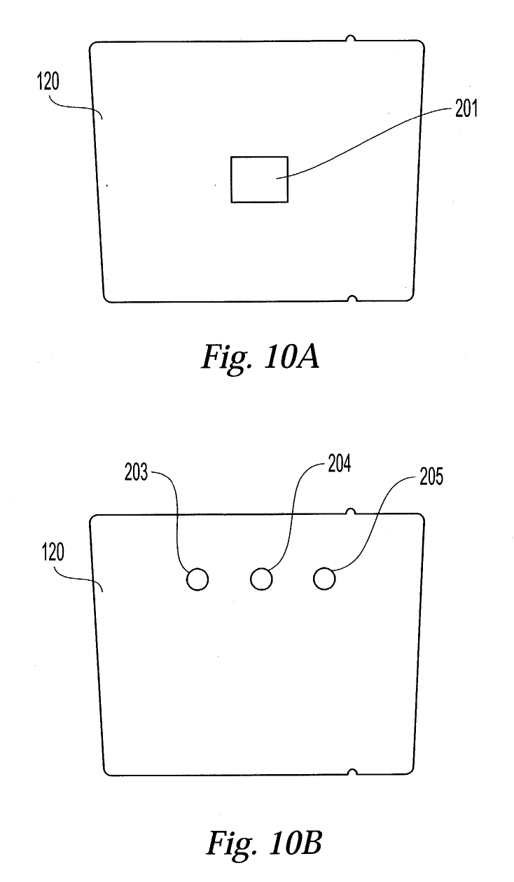

FIG. 10A shows a MEC Box 120 outfitted with an LED display 201, which can effectively serve as an electronic label. The battery used to power LED 201 display would be located on a MEC Cart or other MEC enabled carrier (e.g., a MEC Pallet or MEC Shelf). Accordingly, one battery on a MEC Cart could drive a large number of LED displays located on boxes above it. Similarly, other essential components of the LED display, such as circuitry and keypads, could be located on a MEC Cart rather than on each box, resulting in a savings of money, space and weight.

FIG. 10B shows a MEC Box 120 outfitted with colored lights: yellow light 203, blue light 204 and green light 205. Colored lights 203, 204 and 205 may include LEDs. The concepts are the same as those discussed in connection with FIG. 10A above, i.e., the battery on a MEC Cart or other MEC enabled carrier can be used to power the lights and turn then on and off differentially.

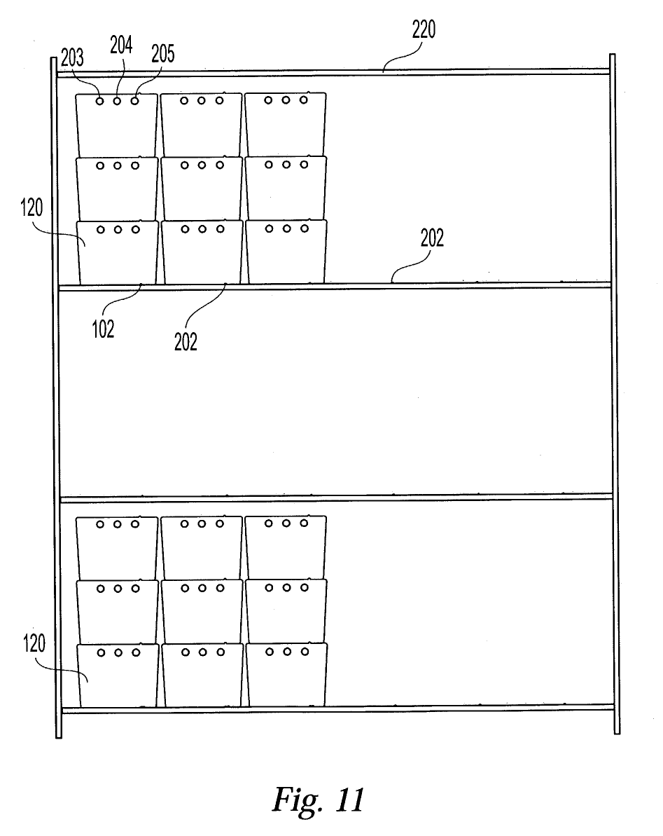

FIG. 11 shows a MEC outfitted shelving unit 220 (hereinafter referred to as a “MEC Shelf”). The top of each shelf is outfitted with one or more Metal Male Nodules 202, which are preferably similar to the type of Metal Male Nodule 101, 105 shown in FIGS. 1 and 5. Male Nodules 202 mate with the Female Nodules 102 on the floors of the bottom MEC Boxes 120 in the stacks shown. The MEC boxes are effectively connected to the MEC Shelf which can be connected via either an RFDC Unit or a cable to a computer or other communications device.

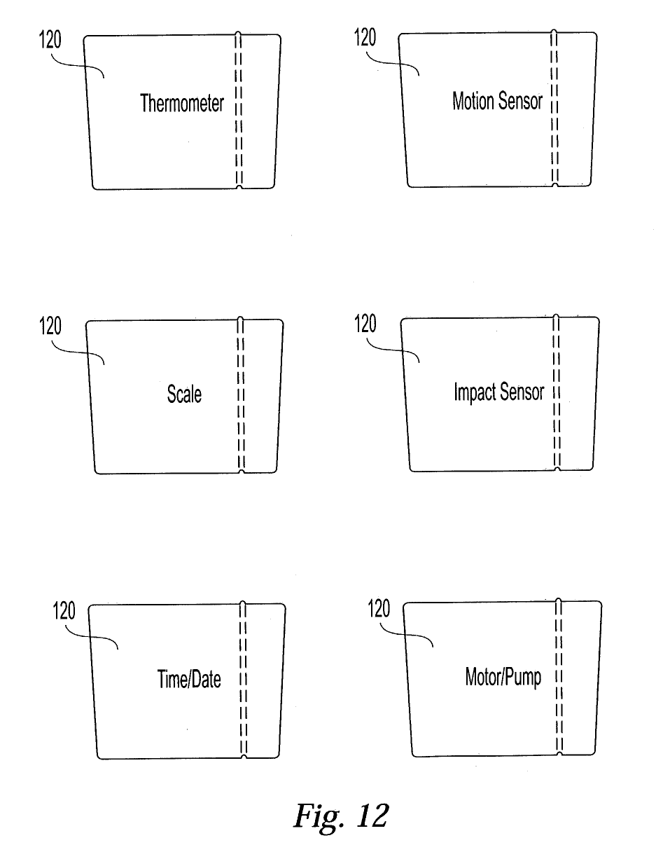

FIG. 12 exemplifies some of the devices that could be attached to a MEC Box 120. As shown, such devices include a thermometer, a motion sensor, a scale, an impact sensor, a calendar/clock indicating the time and date, and a motor or pump. As discussed above, the battery or other source used to power such devices would be on a MEC Cart or other MEC enabled carrier. Accordingly, one battery on a MEC Cart could drive many different electrical devices in a stack of MEC Boxes 120. Similarly, other essential components of the various devices could be located on a MEC Cart rather than on each box (e.g. an output device for a thermometer), resulting in savings of money, space and weight.

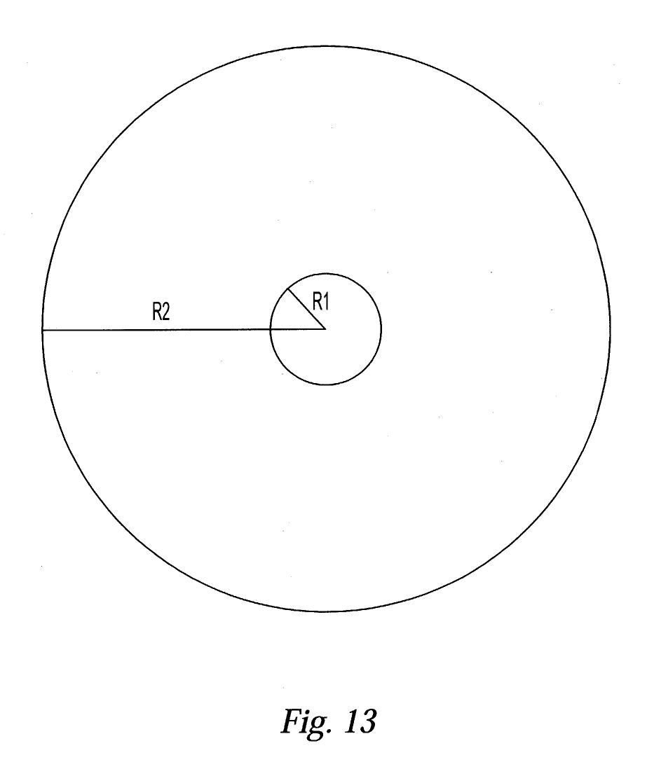

An “active” RFID tag has its own battery built into the tag. Less expensive “passive” RFID tags do not have their own batteries, but receive power from an RFID antenna. Active tags are generally more expensive and have a longer transmittal range than passive tags. It is possible that the battery on a MEC enabled carrier could be used to provide power to an otherwise passive tag, thereby providing the range of an active tag at about the price of a passive tag. As shown in FIG. 13, the range R1 of a passive tag, which may be on the order of 10 feet, is much less than the range R2 of an active tag, which may be on the order of 1000 feet.

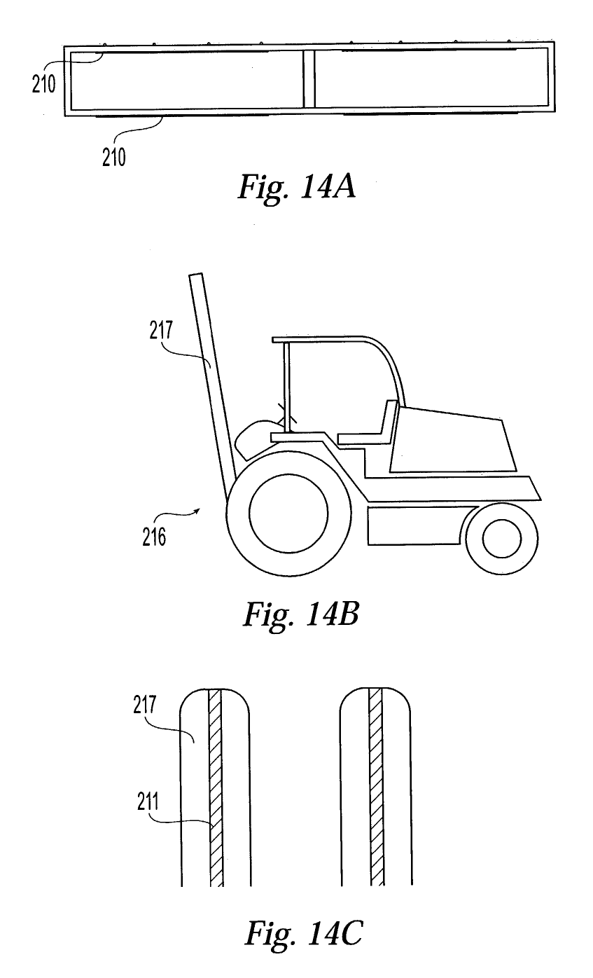

FIG. 14A shows a MEC outfitted pallet (hereinafter referred to as a “MEC Pallet”). The underside of the top surface of the MEC Pallet is outfitted with a metal plate 210. Blades 217 of forklift truck 216 (shown in FIG. 14B) can be inserted into the pallet. As shown in FIG. 14C, each blade is outfitted with a Metal Strip 211, indicated by diagonal stripes (hereinafter referred to as a “MEC Blade”). When the MEC Blades are inserted into the MEC Pallet, Metal Strips 211 and metal plates 210 make contact with each other. Accordingly, the MEC Pallet is effectively connected to the MEC Blades 217 which can communicate via an RFDC Unit to a computer or other device. The RFDC Unit would typically be located on the forklift truck. Any MEC Boxes sitting atop the MEC Pallet can be added to the communications channel.

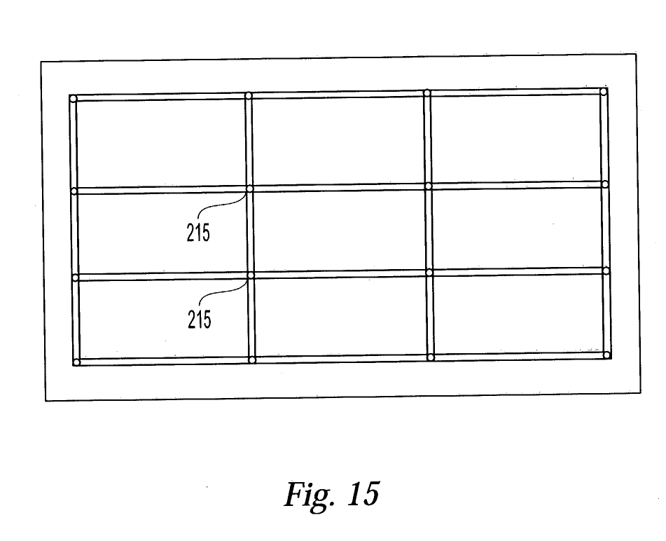

FIG. 15 is an aerial view of the circuitry located on the underside of a MEC Cart, MEC Shelf, MEC Pallet or other MEC carrier. Essentially, the circuitry forms a grid, so that all MEC Boxes atop the MEC carrier are connected to each other. A MEC Nodule 215 is at each grid intersection.

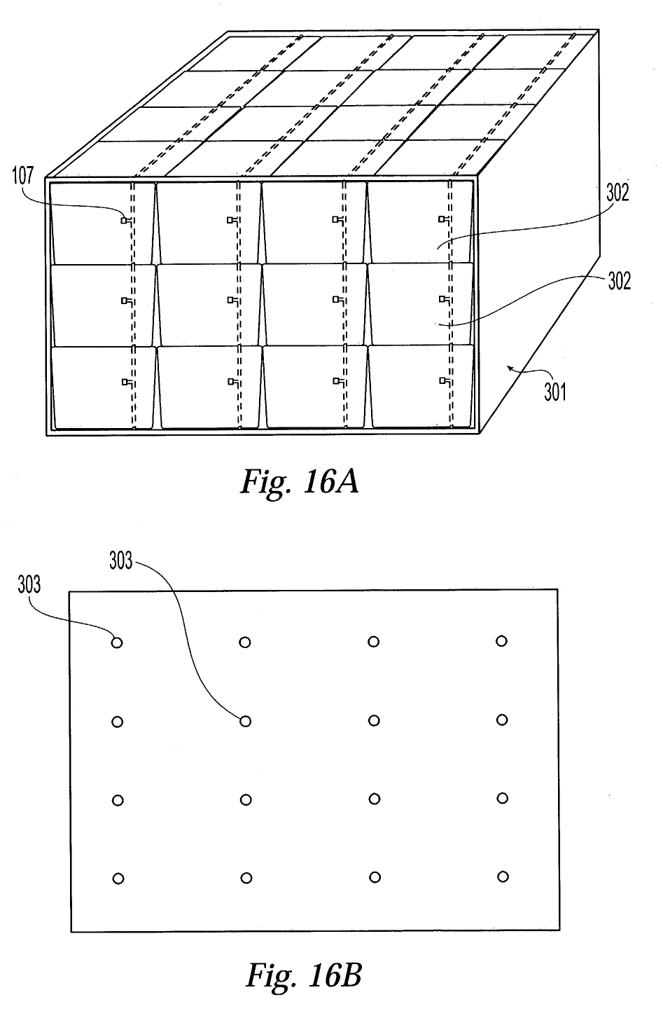

FIG. 16A shows large MEC Box 301 which holds other smaller MEC Boxes 302. Each of the small boxes 302 is outfitted with a computer chip 107. An aerial view of the floor of the large box (FIG. 16B), shows that it is outfitted with Metal Male MEC Nodules 303. Accordingly, since the large box is in communication will all smaller boxes, the large MEC Box can know its own content. If a smaller box is removed or added, that could be communicated to the large MEC Box and from there to various other communications devices.

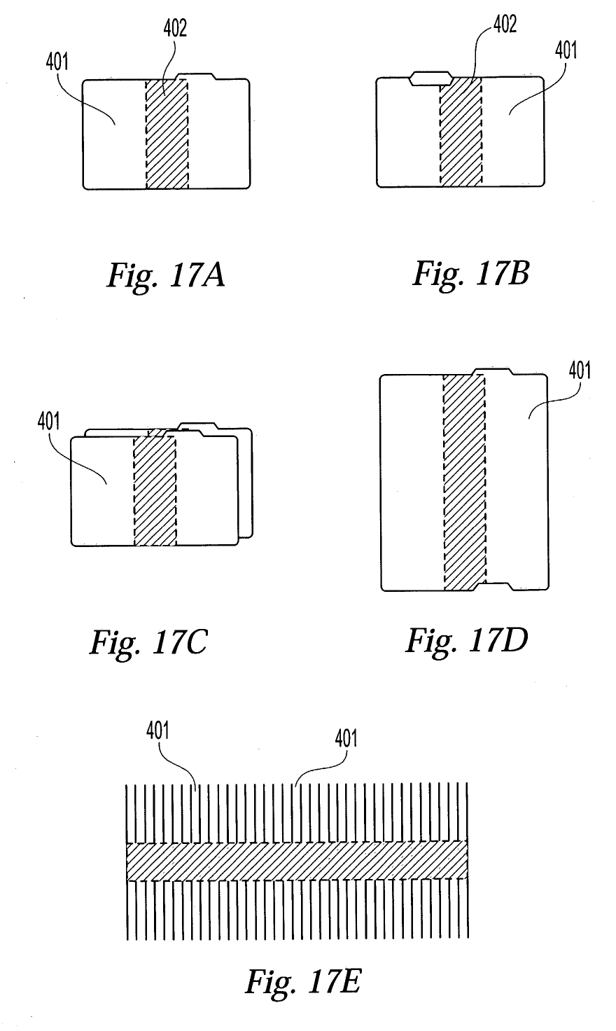

FIGS. 17A and 17B show the front and back sides of a “MEC File Folder” 401. In the embodiment shown, file folder 401 have been imprinted or stamped with a metallic coating 402 in the shape of a broad vertical stripe. The stripe covers both the front and back of file folders 401. FIG. 17C shows two stacked file folders, such that the metallic coating on the back of the front folder makes contact with the metallic coating on the front of the back cover. The same concept could be applied to books and other objects. FIG. 17E shows an aerial view of a plurality of stacked MEC file folders 401. FIG. 17D shows a MEC file folder 401 opened flat.

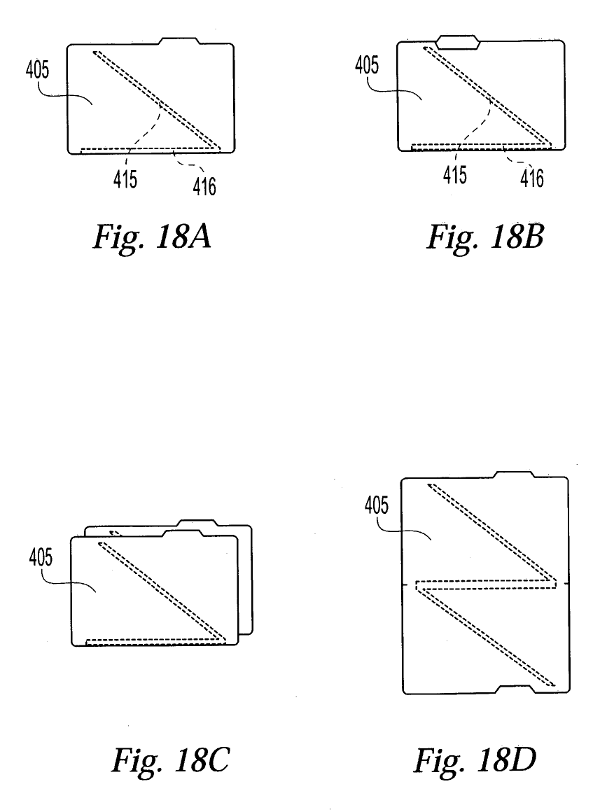

FIGS. 18A-18D show another preferred embodiment of a MEC File Folder 405 with a metallic coating is in the form of a diagonal line 415 across each of the front and back of folders 405. Horizontal strip of metallic coating 416 across the bottom of the folder connects the front and back diagonals. FIG. 18C shows two stacked file folders 405, such that the metallic coating on the back of the front folder makes contact with the metallic coating on the front of the back cover. The same concept could be applied to books. FIG. 18D shows a MEC file folder 405 opened flat.

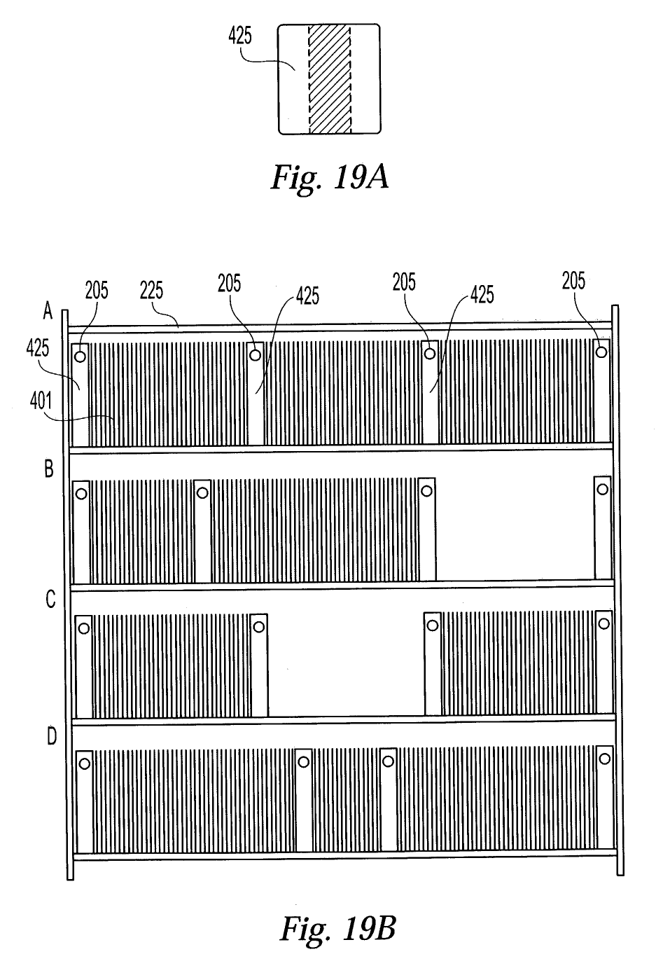

FIG. 19B shows MEC File Folders 401 (as described above) on a shelving unit 225 outfitted with Rigid MEC Dividers (RMDs) 425. An RMD is a rigid rectangular board that might typically be made of plastic. The board contains a metallic coating in the shape of a broad vertical stripe (in the same manner as described in FIGS. 17A-17B). RMD 425 is attached to shelving unit 225 and can be slid along the shelves in order to keep MEC File Folders 401 upright and compactly in place. An RMD 425 and an adjacent MEC File Folder 401 can communicate with each other by virtue of the contact between their metallic coatings. Similarly, all MEC File Folders 401 can communicate with their adjacent MEC File Folders. This allows any and all MEC File Folders 401 to communicate with RMD 425, which can effectively communicate with a computer or other device via either an RFDC Unit or through a cable.

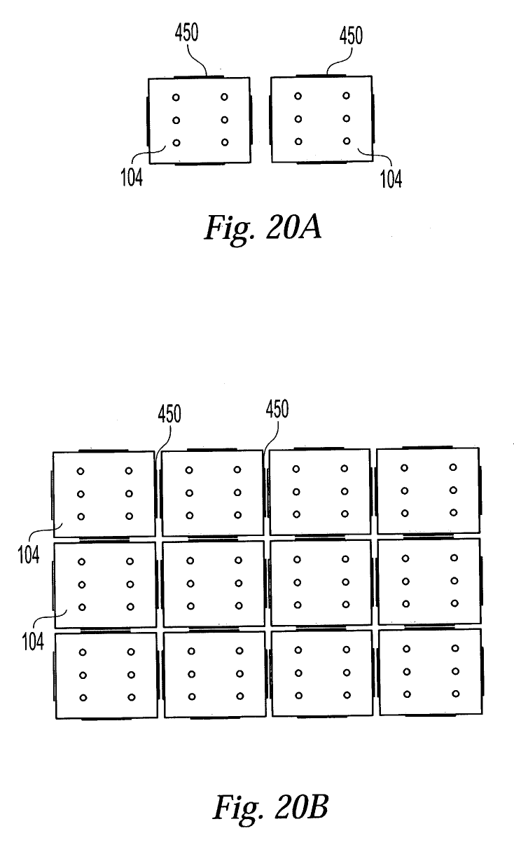

FIG. 20A shows a pair of MEC carts 104, where each cart has a metal plate 450 attached to each of its four sides. When multiple carts 104 are arranged in the configuration shown in FIG. 20B, the plates contact each other, thereby providing connectivity between and creating a network of linked MEC Carts 104.

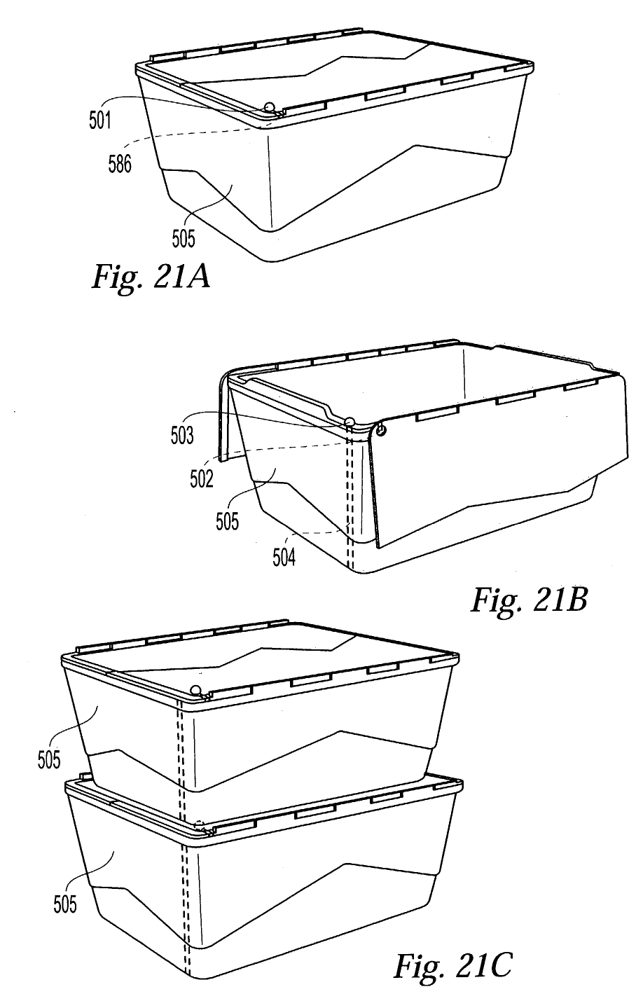

FIGS. 21A-21C shows how a Modular Electronic Connector could be configured on a plastic box 505 with a hinged lid. As shown in FIG. 21A, Metal Male Nodule 501 is attached near a corner at the top of the lid. Metal filament 586 runs a short distance from Nodule 501 to the edge of the lid. At the edge, filament 586 turns down and extends around the underside of the lid, where it attaches to the a Metal Female Nodule 502 (shown in FIG. 21B. Metal Male Nodule 503 is attached to the shoulder of the box and is attached to metal filament 504 which runs to the bottom of the box at which point, such filament 586 is attached to a Metal Female Nodule (not shown). When the lid is closed (see FIG. 21C), Metal Male Nodule 503 mates with the Female Nodule 502 on the lid, thereby effectively connecting Male Nodule 501 on the lid to Female Nodule at the bottom of the box (not shown). FIG. 21C shows a stack of two connected plastic MEC Boxes 505 with hinged lids.

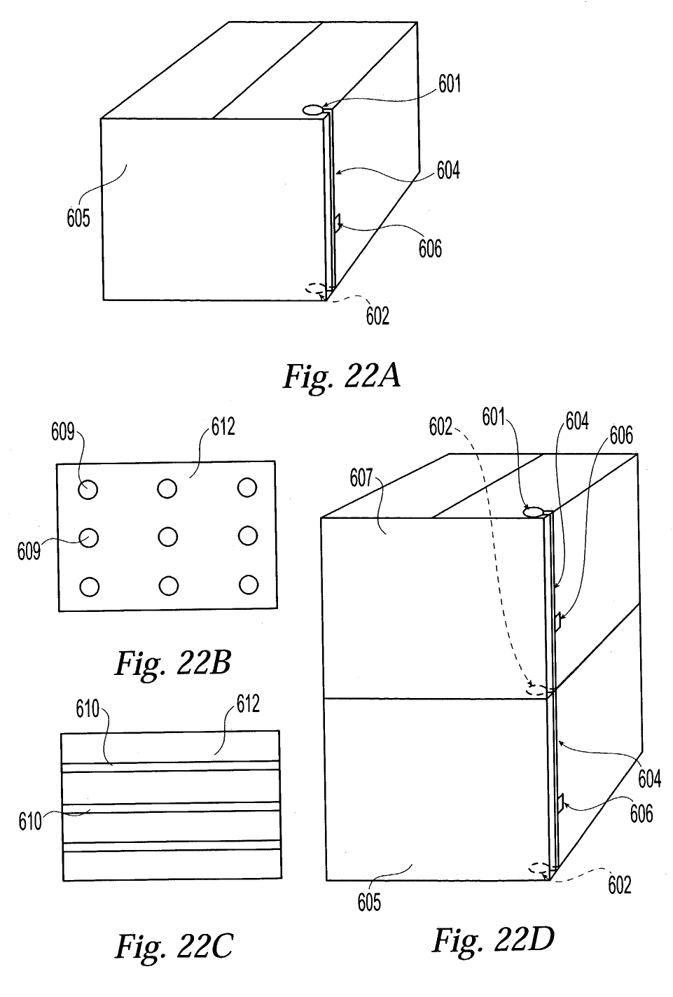

FIGS. 22A-22D shows an embodiment of the current invention in which a Modular Electronic Connector has been configured on a corrugated box 605. The configuration is similar to the one described in FIG. 1, except that the top and bottom nodules 101, 102 (shown in FIG. 1) have been replaced by flat metallic contact surfaces 601 and 602 (shown as circles in FIGS. 22A and 22D) that have been printed or stamped on the outside of box 605. Metal filament 604, connecting the top and bottom contact surfaces has also been printed on the outside of the box and a computer chip 606 has been attached to such filament. FIG. 22D shows two MEC outfitted corrugated boxes 605 with the bottom metal surface 602 of the upper box 607 in contact with the top metal surface 601 of the lower box 605. FIGS. 22B and 22C are aerial views of the tops of carriers 612 (e.g., carts, shelves or pallets) that have been “MEC outfitted” to be compatible with boxes 605. FIG. 22B shows metal circles 609, and FIG. 22C shows metal strips 610, that would be positioned to mate with the bottom metal contacts of MEC Outfitted corrugated boxes sitting on such carriers. Such circles, strips or other shapes could be printed or stamped on the carriers, or attached as metal plates.

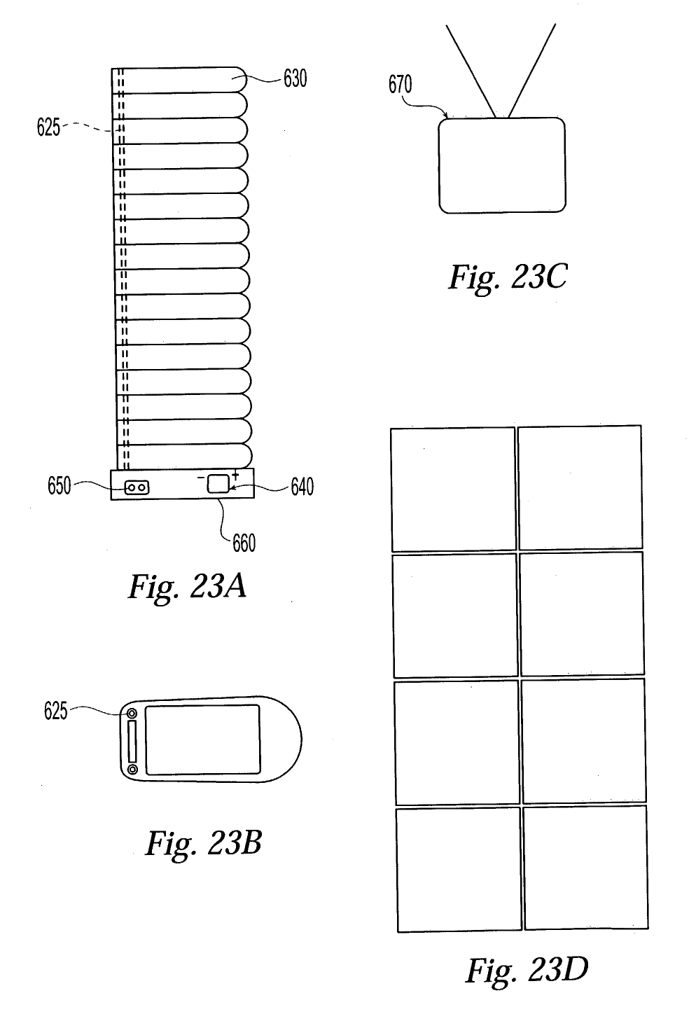

FIG. 23A shows Modular Electronic Connectivity used on RFID tags 630 (numbered 1 through 16), rather than on boxes. RFID tags can be made in many shapes. In the embodiment shown, the form which holds the electronic elements of the tag is made of rigid plastic. An aerial view of the tag is shown in FIG. 23B and a side view of a stack of tags is shown in FIG. 23A. FIG. 23B shows a metal filament 625 passing through a hole in the tag. Filament 625 would have metal male and female nodules at its top and bottom, respectively. As shown by the set of vertical dotted lines 625 in FIG. 23A, the tags in the stack are electronically connected to each other, as well as to a battery 640 and an RFDC Unit 650 in a MEC base 660.

As an example of a possible application, a command from a computer through RFDC Unit 650 could cause the top tag in the stack (tag #1) to be activated while the other tags remain deactivated. Accordingly, RFID antenna 670 (FIG. 23C) would read only tag #1. Thereafter, tag #1 could be removed from the stack and attached to corrugated box #1 (shown in FIG. 23D). A second command from the computer could cause the new top tag in the stack (tag #2) to be activated while the other tags remain deactivated. Accordingly, RFID antenna 670 (FIG. 23C) would read only the tag #2. Tag #2 could be removed from the stack and attached to corrugated box #2 (shown in FIG. 23D). Continuing in this manner, each tag could be associated with the box to which it is attached.

While the present invention has been described with reference to the preferred embodiments, those skilled in the art will recognize that numerous variations and modifications may be made without departing from the scope of the present invention. Accordingly, it should be clearly understood that the embodiments of the invention described above are not intended as limitations on the scope of the invention, which is defined only by the following claims.

What is claimed is:

1. A storage unit system comprising:
a plurality of stackable storage units, each storage unit having an electrical connection between itself and adjacent storage units in a stack of storage units, the electrical connections enabling an electric current to flow from storage unit to storage unit, and to electrically powered devices that may be attached to such storage units.

2. The system of claim 1, further comprising:
a carrier for carrying a plurality of stacked storage units;
a central power source on the carrier that is attached to, and supplies electrical power to, a first storage unit,
such electrical power flowing to adjacent storage units through the electrical connections.

3. A trackable storage unit system comprising:
a plurality of stackable storage units, each storage unit having a computer chip containing data concerning the storage unit;
a carrier for carrying a plurality of stacked storage units, the carrier having a first transceiver;
electrical connections between the carrier and at least a first storage unit in the stack of storage units carried by the carrier and between adjacent storage units in the stack of storage units carried by the carrier, the electrical connections enabling the first transceiver on the carrier to transmit and receive data to and from the computer chips of the storage units in the stack of storage units; and
a second remote transceiver for receiving and transmitting data to and from the first transceiver
wherein the second remote transceiver transmits and receives data to and from the computer chips of the plurality of storage units via the first transceiver and the electrical connections to track the plurality of storage units.

4. The system of claim 3, further comprising a central power source on the carrier for supplying power to the computer chips in the stack of storage units via the electrical connections between the storage units.

5. The system of claim 3, wherein the plurality of storage units are stacked vertically.

6. The system of claim 3, wherein the plurality of storage units are stacked horizontally.

7. The system of claim 3, wherein the plurality of storage units are boxes.

8. The system of claim 3, wherein the plurality of storage units are file folders.

9. The system of claim 3, wherein the carrier is a cart.

10. The system of claim 3, wherein the carrier is a shelving unit.

11. The system of claim 3, wherein the carrier is a cargo pallet.

12. The system of claim 3, wherein the data contained on each computer chip includes identification data.

13. In a storage unit system having a plurality of stackable storage units, with each storage unit having a computer chip containing data concerning the storage unit, a storage unit carrier having a first transceiver with electrical connections between the carrier and at least a first storage unit in the stack of storage units carried by the carrier and between adjacent storage units in the stack of storage units carried by the carrier, and a second remote transceiver for receiving and transmitting data to and from the first transceiver, a method for tracking the plurality of storage units comprising:
transmitting data between the computer chips in the stack of storage units and the first transceiver on the carrier via the electrical connections between adjacent storage units in the stack of storage units;
transmitting the data between the first transceiver and the second transceiver; and
monitoring the data received by the second transceiver.

14. The method of claim 13, wherein a central power source on the carrier supplies power to the computer chips in the stack of storage units via the electrical connections between the storage units.

15. The method of claim 13, wherein the plurality of storage units are stacked vertically.

16. The method of claim 13, wherein the plurality of storage units are stacked horizontally.

17. The method of claim 13, wherein the plurality of storage units are boxes.

18. The method of claim 17, wherein the boxes include a display.

19. The method of claim 13, wherein the plurality of storage units are file folders.

20. The method of claim 13, wherein the carrier is a cart.

21. The method of claim 13, wherein the carrier is a shelving unit.

22. The method of claim 13, wherein the carrier is a cargo pallet.

23. The method of claim 13, wherein the data contained on each computer chip includes identification data.

24. A trackable storage unit system comprising:
a plurality of storage units, each storage unit having a computer chip containing data concerning the storage unit;
a carrier for carrying a plurality of storage units, the carrier having a first transceiver;
a central power source connected to the carrier for supplying power to the computer chips of the plurality of storage units;
electrical connections between the carrier and each of the plurality of storage units carried on the carrier, the electrical connections enabling the central power source to supply power to the computer chips of the storage units in contact with the carrier and enabling the first transceiver on the carrier to transmit and receive data to and from the computer chips of the plurality of storage units in contact with the carrier; and
a second remote transceiver for receiving and transmitting data to and from the first transceiver
wherein the second remote transceiver transmits and receives data to and from the computer chips of the plurality of storage units via the first transceiver and the electrical connections to track the plurality of storage units.

25. The system of claim 24, wherein the plurality of storage units are boxes.

26. The system of claim 25, wherein the boxes include a display.

27. The system of claim 24, wherein the plurality of storage units are file folders.

28. The system of claim 24, wherein the carrier is a shelving unit.

29. The system of claim 24, wherein the data contained on each computer chip includes identification data for each storage unit.

30. In a storage unit system having a plurality of storage units, with each storage unit having a computer chip containing data concerning the storage unit, a storage unit carrier having a first transceiver with electrical connections between the carrier and each of the plurality of storage units carried on the carrier, a central power source connected to the carrier for supplying power to the computer chips of the plurality of storage units via the electrical connections, and a second remote transceiver for receiving and transmitting data to and from the first transceiver, a method for tracking the plurality of storage units comprising:
supplying power to the computer chips of the plurality of storage units in contact with the carrier via the electrical connections;
transmitting data between the computer chips of the plurality of storage units in contact with the carrier and the first transceiver on the carrier via the electrical connections;
transmitting the data between the first transceiver and the second transceiver; and
monitoring the data received by the second transceiver.

31. The method of claim 30, wherein the plurality of storage units are boxes.

32. The method of claim 31, wherein each of the boxes includes a display.

33. The method of claim 30, wherein the plurality of storage units are file folders.

34. The method of claim 30, wherein the carrier is a shelving unit.

35. The method of claim 30, wherein the data contained on each computer chip includes identification data.
